(19) United States
(12) Patent Application Publication
(10) Pub. No.: US 2023/0407812 A1
(43) Pub. Date: Dec. 21, 2023

(54) STIRLING ENGINE, AND METHOD FOR ADJUSTING SAME

(71) Applicant: Twinbird Corporation, Niigata (JP)

(72) Inventors: Mineyuki Inoue, Niigata (JP); Jun Tanikawa, Niigata (JP); Kiyotaka Oda, Niigata (JP)

(73) Assignee: Twinbird Corporation, Niigata (JP)

(21) Appl. No.: 18/272,032

(22) PCT Filed: Dec. 13, 2021
(86) PCT No.: PCT/JP2021/045786

§ 371 Date: Jul. 12, 2023

(30) Foreign Application Priority Data
Jan. 28, 2021 (JP) 2021-011668

(51) Int. Cl. F02G 1/053; F02G 1/043

(52) U.S. Cl. CPC F02G 1/053; F02G 1/0435; F02G 2243/02

(57) ABSTRACT

Provided is a Stirling engine whose characteristics can be easily adjusted. In a Stirling refrigerator as a Stirling engine including a piston as a reciprocating body that is configured to be able to reciprocate inside a cylinder having a central axis line X, and a mover of a linear motor and a connector as moving bodies that are coupled to and move together with this piston, since there is provided spacer(s) as an adjustment mechanism capable of adjusting the static position of a tip end of the piston inside the cylinder by adjusting the positional relation between the mover and the piston, the characteristics of the Stirling refrigerator can be easily adjusted.

### TECHNICAL FIELD

The present invention relates to a Stirling engine and a method for adjusting the same.

### BACKGROUND ART

Conventionally, as such a type of Stirling engine, there is known one having a casing, a cylinder that is provided in the casing and has a central axis line, a piston (corresponding to a reciprocating body of the invention of this application) that is coaxial with the cylinder and is configured to be able to reciprocate inside the cylinder, and a displacer (corresponding to the reciprocating body of the invention of this application) that is coaxial with the cylinder and is configured to be able to reciprocate inside the cylinder, where a compression chamber is provided between the piston and the displacer in the cylinder, and an expansion chamber is provided on a side of the displacer that is opposite to the piston in the casing (e.g. Patent document 1). Further, the volumes and pressures of the compression and expansion chambers vary depending on the motions of the piston and displacer. Furthermore, the compression chamber and the expansion chamber are communicated with each other.

### PRIOR ART DOCUMENTS

### Patent Documents

Patent document 1: Japanese Patent No.3769751

### SUMMARY OF THE INVENTION

### Problems to be Solved by the Invention

In the case of such Stirling engine, the characteristics thereof change depending on the volume of the compression chamber and the volume of the expansion chamber. For example, if the Stirling engine is a Stirling refrigerator, it is conceivable that a lowest temperature achieved around the expansion chamber, temperature drop rate, operation frequency, power consumption or the like will change. Here, while it is desired that these characteristics are able to be previously adjusted in accordance with an intended purpose of the Stirling engine, they are bound to particular physical dimensions with the conventional structures. Further, even when carrying out a dimensional adjustment that is considered as a minor adjustment for the purpose of adjusting the characteristics of a Stirling engine, parts production has always been necessary whenever adjustment occurs.

It is an object of the present invention to solve the above problem by providing a Stirling engine whose characteristics can be easily adjusted, and a method for adjusting the same.

### Means to Solve the Problems

A Stirling engine described in Claim 1 of the present invention includes: a reciprocating body that is configured to be able to reciprocate inside a cylinder having a central axis line; a moving body that is coupled to and moves together with the reciprocating body; and an adjustment mechanism capable of adjusting a static position of the reciprocating body inside the cylinder by adjusting a positional relation between the moving body and the reciprocating body.

Further, a Stirling engine described in Claim 2 of the present invention is such that, in Claim 1, the adjustment mechanism is the spacer(s) provided between the moving body and the reciprocating body.

Furthermore, a Stirling engine described in Claim 3 of the present invention is such that, in Claim 1, the adjustment mechanism is configured to include a first step portion provided at the reciprocating body and a second step portion provided at the moving body, at least one of the first step portion and the second step portion has multiple steps of abutting surfaces with different positions in the direction of the central axis line, the first step portion and the second step portion are configured to face each other, and there can be selected the abutting surfaces of the first step portion and second step portion that are to abut against each other.

Furthermore, a Stirling engine described in Claim 4 of the present invention includes: a reciprocating body that is configured to be able to reciprocate inside a cylinder having a central axis line; a moving body that is coupled to and moves together with the reciprocating body; a control body that is coupled to the moving body and controls the motions of the reciprocating body and the moving body; and an adjustment mechanism capable of adjusting a static position of the reciprocating body inside the cylinder by adjusting a positional relation between the moving body and the control body.

Furthermore, a Stirling engine described in Claim 5 of the present invention is such that, in Claim 4, the adjustment mechanism is the spacer(s) provided between the moving body and the control body.

Furthermore, a Stirling engine described in Claim 6 of the present invention is such that, in Claim 4, the adjustment mechanism includes a first step portion provided at the moving body and a second step portion provided at the control body, at least one of the first step portion and the second step portion has multiple steps of abutting surfaces with different positions in the direction of the central axis line, the first step portion and the second step portion are configured to face each other, and there can be selected the abutting surfaces of the first step portion and second step portion that are to abut against each other.

Furthermore, a method described in Claim 7 of the present invention for adjusting a Stirling engine is such that the Stirling engine includes: a reciprocating body that is configured to be able to reciprocate inside a cylinder having a central axis line; and a moving body that is coupled to and moves together with the reciprocating body, and that a static position of the reciprocating body inside the cylinder is adjusted by employing a plurality of the reciprocating bodies with different lengths in the direction of the central axis line and coupling any of these reciprocating bodies to the moving body.

Furthermore, a method described in Claim 8 of the present invention for adjusting a Stirling engine is such that the Stirling engine includes: a reciprocating body that is configured to be able to reciprocate inside a cylinder having a central axis line; and a moving body that is coupled to and moves together with the reciprocating body, and that a static position of the reciprocating body inside the cylinder is adjusted by employing a plurality of the moving bodies with different lengths in the direction of the central axis line and coupling any of these moving bodies to the reciprocating body.

### Effects of the Invention

As for the Stirling engine described in Claim 1 of the present invention, due to the above configuration, the adjustment mechanism allows the static position of the reciprocating body inside the cylinder to be adjusted, thereby making it possible to easily adjust the characteristics of the Stirling engine.

Here, when the adjustment mechanism is the spacer(s) provided between the moving body and the reciprocating body, the characteristics of the Stirling engine can be adjusted more easily.

Further, the adjustment mechanism includes the first step portion provided at the reciprocating body and the second step portion provided at the moving body, at least one of the first step portion and the second step portion has multiple steps of the abutting surfaces with different positions in the direction of the central axis line, the first step portion and the second step portion are configured to face each other, and there can be selected the abutting surfaces of the first step portion and second step portion that are to abut against each other. Thus, the characteristics of the Stirling refrigerator can be adjusted more easily without increasing mass or the number of components.

Furthermore, as for the Stirling engine described in Claim 4 of the present invention, due to the above configuration, the adjustment mechanism allows the static position of the reciprocating body inside the cylinder to be adjusted, thereby making it possible to easily adjust the characteristics of the Stirling engine.

Here, when the adjustment mechanism is the spacer(s) provided between the moving body and the control body, the characteristics of the Stirling engine can be adjusted more easily.

Further, the adjustment mechanism is configured to include the first step portion provided at the moving body and the second step portion provided at the control body, at least one of the first step portion and the second step portion has multiple steps of the abutting surfaces with different positions in the direction of the central axis line, the first step portion and the second step portion are configured to face each other, and there can be selected the abutting surfaces of the first step portion and second step portion that are to abut against each other. Thus, the characteristics of the Stirling refrigerator can be adjusted more easily without increasing mass or the number of components.

Furthermore, as for the method described in Claim 7 of the present invention for adjusting the Stirling engine, by performing the method in the above manner, the static position of the reciprocating body inside the cylinder can be adjusted, thereby making it possible to easily adjust the characteristics of the Stirling engine.

Furthermore, as for the method described in Claim 8 of the present invention for adjusting the Stirling engine, by performing the method in the above manner, the static position of the reciprocating body inside the cylinder can be adjusted, thereby making it possible to easily adjust the characteristics of the Stirling engine.

### BRIEF DESCRIPTION OF THE DRAWINGS

FIG. 1 is an overall cross-sectional view showing a Stirling refrigerator as a Stirling engine of a first embodiment of the present invention.

FIG. 2 is a series of exploded cross-sectional views showing an assembly that includes a piston as a reciprocating body and a mover and connector as moving bodies in the Stirling refrigerator as the Stirling engine of the first embodiment of the present invention.

FIG. 3 is a series of exploded cross-sectional views showing an assembly that includes a piston as a reciprocating body and a mover and connector as moving bodies in a Stirling refrigerator as a Stirling engine of a second embodiment of the present invention.

FIG. 4 is a series of explanatory diagrams showing main parts of the piston as the reciprocating body and the mover as the moving body that have been rolled out in a circumferential direction, in the case of the Stirling refrigerator as the Stirling engine of the second embodiment of the present invention.

FIG. 5 is a series of exploded cross-sectional views showing an assembly that includes a piston as a reciprocating body and a mover and connector as moving bodies in a Stirling refrigerator as a Stirling engine of a third embodiment of the present invention.

FIG. 6 is a series of exploded cross-sectional views showing an assembly that includes a displacer as a reciprocating body, a rod as a moving body, and a second leaf spring as a control body in a Stirling refrigerator as a Stirling engine of a fourth embodiment of the present invention.

FIG. 7 is a series of exploded cross-sectional views showing an assembly that includes a displacer as a reciprocating body, a rod as a moving body, and a second leaf spring as a control body in a Stirling refrigerator as a Stirling engine of a fifth embodiment of the present invention.

FIG. 8 is a series of explanatory diagrams showing an assembly that includes a piston as a reciprocating body, a mover and connector as moving bodies, and a first leaf spring as a control body in a Stirling refrigerator as a Stirling engine of a sixth embodiment of the present invention, in which (a) is an exploded cross-sectional view, (b) is an external view of the connector when viewed from the first leaf spring side, and (c) is an external view of the first leaf spring when viewed from the connector side.

FIG. 9 is a series of explanatory diagrams showing main parts of the connector as the moving body and the first leaf spring as the control body that have been rolled out in a circumferential direction, in the case of the Stirling refrigerator as the Stirling engine of the sixth embodiment of the present invention.

### MODE FOR CARRYING OUT THE INVENTION

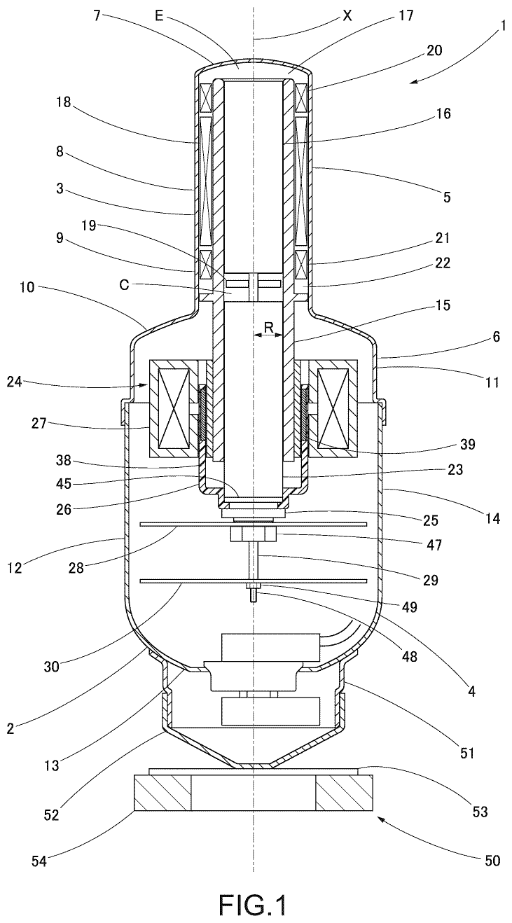

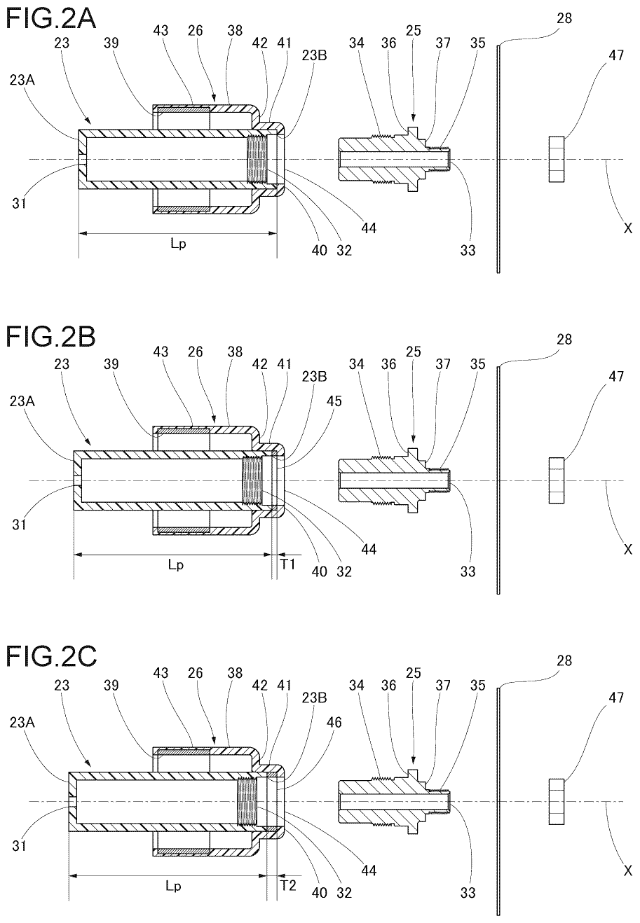

A first embodiment of the present invention is described hereunder with reference to FIGS. 1 and 2. A numerical symbol “1” represents a free piston-type Stirling refrigerator as a Stirling engine. This Stirling refrigerator 1 has a metallic casing 2. Further, this casing 2 has a first casing body 3 and a second casing body 4. The first casing body 3 integrally has a cylindrical portion 5 formed into the shape of a small-diameter cylinder; and a large-diameter portion 6 whose base end is open. Moreover, the cylindrical portion 5 has a closed tip end portion 7, an intermediate portion 8 and a base portion 9. In addition, the large-diameter portion 6 has a first end surface portion 10 formed into the shape of a substantially circular protruding curved surface; and a side surface portion 11 having a short cylindrical shape. Similarly, the second casing body 4 has a cylindrical side surface portion 12; and a second end surface portion 13 formed into the shape of a substantially circular protruding curved surface. Further, a cylindrical trunk portion 14 is formed of the large-diameter portion 6 and the second casing body 4.

Inserted in the cylindrical portion 5 is a cylinder 15 that is extended to the inner region of the trunk portion 14 and is coaxial with the cylindrical portion 5. That is, a central axis line X of the cylinder 15 is identical to a central axis line of the cylindrical portion 5. Here, the radius of an inner surface of the cylinder 15 is R. Further, the cylinder 15 is formed of a metal. Furthermore, a displacer 16 as a reciprocating body is housed inside a tip end side of the cylinder 15 in a manner such that the displacer 16 is capable of sliding along the direction of the central axis line X. Furthermore, an expansion chamber E is established between the tip end of the displacer 16 and the tip end portion 7 of the cylindrical portion 5, the internal and external regions of the cylinder 15 are communicated with each other through a gap 17. Furthermore, at the intermediate portion 8, a regenerator 18 is provided between the inner circumference of the cylindrical portion 5 and the outer circumference of the cylinder 15; at the base portion 9, a communication hole 19 connecting the internal and external regions of the cylinder 15 is formed on the cylinder 15 itself. Furthermore, a heat-absorbing fin 20 is provided between the inner circumference of the tip end portion 7 of the cylindrical portion 5 and the outer circumference of the tip end of the cylinder 15; in between the regenerator 18 and the communication hole 19, a heat-releasing fin 21 is provided between the inner circumference of the cylindrical portion 5 and the outer circumference of the cylinder 15. Furthermore, there is established a path 22 starting from an inner tip end of the cylinder 15, and then passing through the gap 17, the heat-absorbing fin 20, the regenerator 18, the heat-releasing fin 21 and the communication hole 19 before arriving at a compression chamber C inside the cylinder 15. Furthermore, in the trunk portion 14, a piston 23 as a reciprocating body is housed inside a base end side of the cylinder 15 in a manner such that the piston 23 is capable of sliding along the direction of the central axis line X. Furthermore, a base end portion of this piston 23 is coaxially connected to a linear motor 24. Here, this linear motor 24 is configured in a way such that it has a mover 26 as a moving body that is connected to the base end portion of the piston 23 through a connector 25 and is coaxially extended around the outer circumference of the base end side of the cylinder 15; and an annular stator 27 that is provided proximal to the outer circumference of the mover 26. Here, the connector 25 is also included in the moving body.

Further, a first leaf spring 28 as a control body for controlling the movement of the piston 23 is connected to the connector 25 for connecting the mover 26 to the piston 23. Furthermore, one end of a rod 29 as a moving body that moves together with the displacer 16 is connected to a base end side of the displacer 16, and a second leaf spring 30 as a control body is connected to the other end of the rod 29. Here, the rod 29 is extended along the direction of the central axis line X by penetrating the center of the piston 23. In addition, the first and second leaf springs 28, 30 are provided in the trunk portion 14 in a way such that they are arranged outside the base end side of the cylinder 15, and the second leaf spring 30 is arranged in a location more distant from the base end side of the cylinder 15 than the first leaf spring 28.

An assembly of the piston 23, connector 25, mover 26 and first leaf spring 28 is described in detail. The piston 23 is formed into the shape of a hollow cylinder. Further, formed in the center of a tip end 23A of the piston 23 is a through hole 31 allowing the rod 29 to be inserted therethrough. Further, a base end 23B side of the piston 23 is open, and a female screw 32 is formed on the inner surface of such opening portion. A through hole 33 is formed in the connector 25 along the direction of the central axis line X, and the rod 29 is to be inserted through this through hole 33. Further, a first male screw 34 and a second male screw 35 are formed on both sides along the direction of the central axis line X. Moreover, there are formed a first clamping surface 36 and a second clamping surface 37 that are respectively proximal to the male screws 34 and 35. The mover 26 is configured to have a frame 38; and a cylindrical permanent magnet 39 fixed to a one end side of this frame 38. The frame 38 is made of a non-magnetic material such as a synthetic resin. Further, the frame 38 is configured in such a manner that it has a clamped portion 40 formed into an annular shape; a guiding cylinder portion 41 configured to extend from an outer circumferential portion of the clamped portion 40 along the central axis line X; an enlarged diameter portion 42 configured to extend outward from a tip end portion of the guiding cylinder portion 41; and a cylinder portion 43 configured to extend from an outer circumferential portion of this enlarged diameter portion 42 along the central axis line X. The permanent magnet 39 is fixed to the cylinder portion 43. Further, a through hole 44 allowing the first male screw 34 of the connector 25 to be inserted therethrough is formed on the clamped portion 40. Here, the first male screw 34 and the female screw 32 are to be screwed together through this through hole 44. In this way, by screwing together the first male screw 34 and the female screw 32, the clamped portion 40 will be sandwiched by the base end 23B of the piston 23 and the first clamping surface 36 of the connector 25. Thus, the piston 23, the connector 25 and the mover 26 are integrally combined together. At that time, the base end 23B side of the piston 23 is to be inserted into the guiding cylinder portion 41 of the frame 38. Here, an annular spacer 45 or 46 as an adjustment mechanism can be placed between the base end 23B of the piston 23 and the clamped portion 40. A through hole (not shown) is formed in the central part of the first leaf spring 28, and the second male screw 35 is to be inserted through this through hole. Further, by allowing a nut 47 to be screwed to the second male screw 35 after inserting the second male screw 35 through the through hole, the first leaf spring 28 will be sandwiched by the second clamping surface 37 of the connector 25 and the nut 47.

A male screw 48 is formed on the other end of the rod 29. A through hole (not shown) is formed in the central part of the second leaf spring 30, and the male screw 48 is to be inserted through this through hole. Further, by allowing a nut 49 to be screwed to the male screw 48 after inserting the male screw 48 through the through hole, the second leaf spring 30 will be sandwiched by the rod 29 and the nut 49.

Here, a numerical symbol “50” in FIG. 1 indicates a vibration absorption unit provided on the second end surface portion 13 of the second casing body 4. This vibration absorption unit is configured in a way such that a leaf spring 53 and a balance weight 54 are coaxially stacked together through an attachment portion 51 coaxial with the central axis line X of the cylinder 15 and a connecting portion 52 connected to the attachment portion 51.

Described hereunder is the adjustment of a static position of the tip end 23A of the piston 23. As shown in FIG. 2, the spacer 45 or 46 can be placed between the base end 23B of the piston 23 and the clamped portion 40 of the frame 38. As shown in FIG. 2(a), it may be that neither the spacer 45 nor the spacer 46 is placed between the base end 23B of the piston 23 and the clamped portion 40 of the frame 38. The thickness of the spacer 45 is T1, and the thickness of the spacer 46 is T2. Here, T2 is twice as large as T1 (2T1=T2). Further, although not shown, instead of using the spacer 46, two spacers 45 may be stacked together along the direction of the central axis line X and placed between the base end 23B of the piston 23 and the clamped portion 40 of the frame 38. Here, the length of the piston 23 is Lp. In addition, after inserting the first male screw 34 of the connector 25 into the through hole 44 of the frame 38 of the mover 26, the first male screw 34 will be screwed to the female screw 32 of the piston 23. In this way, the mover 26 will be sandwiched between the base end 23B of the piston 23 and the first clamping surface 36 of the connector 25, whereby the piston 23 and the mover 26 will be coupled together. Moreover, after inserting the second male screw 35 of the connector 25 into an attachment hole that is not shown and formed in the center of the first leaf spring 28, the second male screw 35 will be screwed to the nut 47. In this way, the first leaf spring 28 will be sandwiched between the second clamping surface 37 of the connector 25 and the nut 47, whereby the connector 25 and the first leaf spring 28 will be coupled together. In this manner, there is established an assembly of the piston 23, connector 25, mover 26 and first leaf spring 28.

In FIG. 2(a), a distance from the clamped portion 40 to the tip end 23A of the piston 23 is identical to the length Lp of the piston 23. Meanwhile, in FIG. 2(b), since the spacer 45 having the thickness of T1 is sandwiched between the base end 23B of the piston 23 and the clamped portion 40, the distance from the clamped portion 40 to the tip end 23A of the piston 23 is Lp+T1. Further, since the spacer 46 having the thickness of T2 is sandwiched between the base end 23B of the piston 23 and the clamped portion 40, the distance from the clamped portion 40 to the tip end 23A of the piston 23 is Lp+T2 (=Lp+2T1). That is, the static position of the tip end 23A of the piston 23 in FIG. 2(b) is more situated toward the displacer 16 than that in FIG. 2(a) by the length of T1. Likewise, the static position of the tip end 23A of the piston 23 in FIG. 2(c) is more situated toward the displacer 16 than that in FIG. 2(a) by the length of T2 (=2T1).

As such, by changing the static position of the tip end 23A of the piston 23, a volume of the compression chamber C formed in the cylinder 15 in a static state will also change. Further, as the volume of the compression chamber C in the static state changes, characteristics of the Stirling refrigerator 1 (e.g. lowest temperature achieved around the expansion chamber E, temperature drop rate, operation frequency and power consumption) will also change. In this way, by sandwiching nothing between the piston 23 and the mover 26, or by merely sandwiching the spacer 45 or 46 therebetween, the characteristics of the Stirling refrigerator 1 can be adjusted.

As described above, the present invention is such that: in the Stirling refrigerator 1 as a Stirling engine including the piston 23 as a reciprocating body that is configured to be able to reciprocate inside the cylinder 15 having the central axis line X, and the mover 26 of the linear motor 24 and the connector 25 as moving bodies that are coupled to and move together with this piston 23, since there is provided the spacer(s) 45, 46 as an adjustment mechanism capable of adjusting the static position of the tip end 23A of the piston 23 inside the cylinder 15 by adjusting the positional relation between the mover 26 and the piston 23, the characteristics of the Stirling refrigerator 1 can be easily adjusted.

Further, by employing, as the adjustment mechanism, the spacer 45, 46 that is provided between the mover 26 and the piston 23, the characteristics of the Stirling refrigerator 1 can be adjusted more easily.

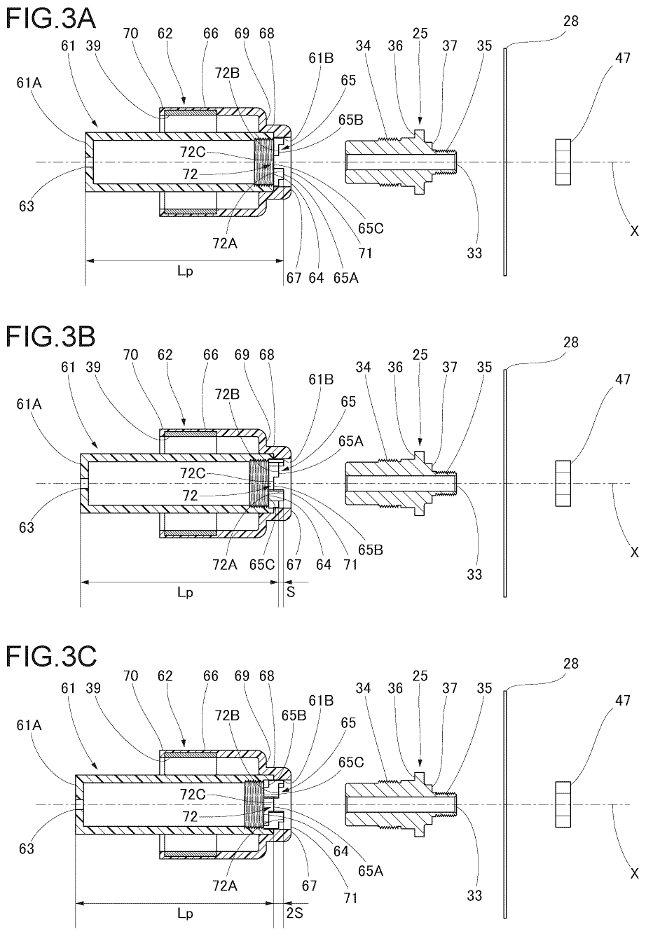

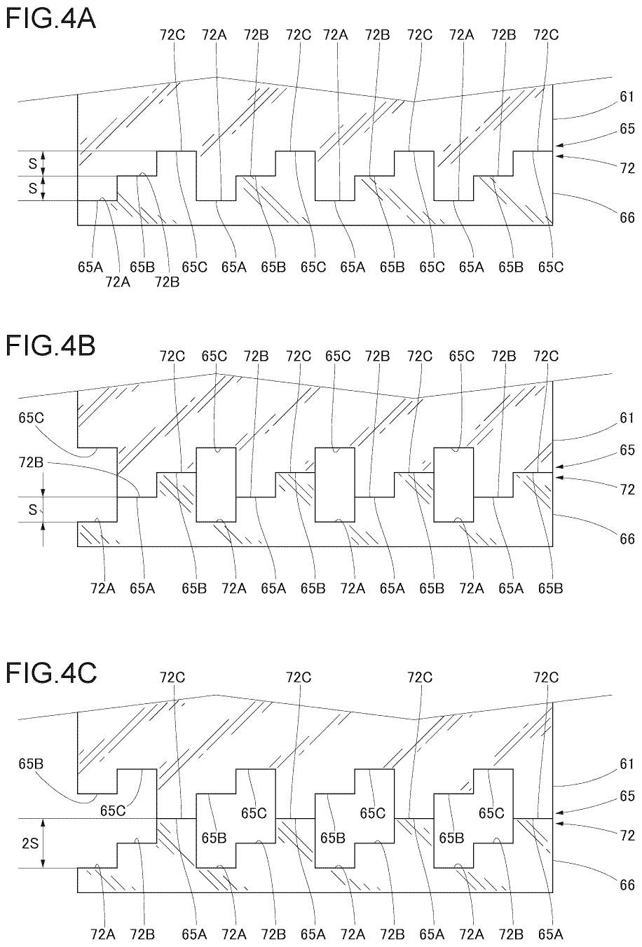

Next, a second embodiment of the present invention is described with reference to FIGS. 3 and 4. Here, parts that correspond to those in the first embodiment are given the same numerical symbols, and the descriptions thereof are thus omitted.

An assembly is formed by a piston 61 as a reciprocating body, a connector 25 as a moving body, a mover 62 as a moving body, and a first leaf spring 28 as a control body. The piston 61 is formed into the shape of a hollow cylinder. Further, formed in the center of a tip end 61A of the piston 61 is a through hole 63 allowing a rod 29 that is to be connected to a displacer 16 to be inserted therethrough. Further, a base end 61B side of the piston 61 is open, and a female screw 64 is formed on the inner surface of such opening portion. Further, a first step portion 65 composing an adjustment mechanism is formed at the base end 61B of the piston 61. A through hole 33 is formed in the connector 25 along the direction of a central axis line X, and the rod 29 is to be inserted through this through hole 33. Further, a first male screw 34 and a second male screw 35 are formed on both sides along the direction of the central axis line X. Moreover, there are formed a first clamping surface 36 and a second clamping surface 37 that are respectively proximal to the male screws 34 and 35. The mover 62 is configured to have a frame 66; and a cylindrical permanent magnet 39 fixed to a one end side of this frame 66. The frame 66 is made of a non-magnetic material such as a synthetic resin. Further, the frame 66 is configured in such a manner that it has a clamped portion 67 formed into an annular shape; a guiding cylinder portion 68 configured to extend from an outer circumferential portion of the clamped portion 67 along the central axis line X; an enlarged diameter portion 69 configured to extend outward from a tip end portion of the guiding cylinder portion 68; and a cylinder portion 70 configured to extend from an outer circumferential portion of this enlarged diameter portion 69 along the central axis line X. The permanent magnet 39 is fixed to the cylinder portion 70. Further, a through hole 71 allowing the first male screw 34 of the connector 25 to be inserted therethrough is formed on the clamped portion 67. Here, the first male screw 34 and the female screw 64 are to be screwed together through this through hole 71. In this way, by screwing together the first male screw 34 and the female screw 64, the clamped portion 67 will be sandwiched by the base end 61B of the piston 61 and the first clamping surface 36 of the connector 25. Thus, the piston 61, the connector 25 and the mover 62 are integrally combined together. At that time, the base end 61B side of the piston 61 is to be inserted into the guiding cylinder portion 68 of the frame 66. Here, a second step portion 72 composing an adjustment mechanism is formed at the clamped portion 67 and the guiding cylinder portion 68. A through hole (not shown) is formed in the central part of the first leaf spring 28, and the second male screw 35 is to be inserted through this through hole. Further, by allowing a nut 47 to be screwed to the second male screw 35 after inserting the second male screw 35 through the through hole, the first leaf spring 28 will be sandwiched by the second clamping surface 37 of the connector 25 and the nut 47.

The first step portion 65 is described in detail hereunder. The first step portion 65 has stepwise abutting surfaces with different heights in the direction of the central axis line X. In this example, it has a first surface 65A, a second surface 65B and a third surface 65C. A plurality of these first surface 65A, second surface 65B and third surface 65C are provided at equal angle intervals along the circumferential direction of the piston 61. In this example, as for each type of the first surface 65A, second surface 65B and third surface 65C, there are respectively provided four at an interval of π/2. The first surface 65A is at a location that is most distant from the tip end 61A of the piston 61. Further, the third surface 65C is at a location that is closest from the tip end 61A of the piston 61. The second surface 65B is positioned in between the first surface 65A and the third surface 65C. Moreover, a step dimension between the first surface 65A and the second surface 65B is S. In addition, a step dimension between the second surface 65B and the third surface 65C is also S.

The second step portion 72 is described in detail hereunder. The second step portion 72 has stepwise abutting surfaces with different heights in the direction of the central axis line X. In this example, it has a first surface 72A, a second surface 72B and a third surface 72C. A plurality of these first surface 72A, second surface 72B and third surface 72C are provided at equal angle intervals along the circumferential direction of the frame 62. In this example, as for each type of the first surface 72A, second surface 72B and third surface 72C, there are respectively provided four at an interval of π/2. The first surface 72A is at a location that is most distant from the tip end 61A of the piston 61. Further, the third surface 72C is at a location that is closest from the tip end 61A of the piston 61. The second surface 72B is positioned in between the first surface 72A and the third surface 72C. Moreover, a step dimension between the first surface 72A and the second surface 72B is S. In addition, a step dimension between the second surface 72B and the third surface 72C is also S.

Described hereunder is the adjustment of a static position of the tip end 61A of the piston 61. As shown in FIGS. 3 and 4, the first surface 65A to third surface 65C of the first step portion 65 are capable of abutting against the first surface 72A to third surface 72C of the second step portion 72. In FIG. 3(a), the first surface 65A of the first step portion 65 abuts against the first surface 72A of the second step portion 72; the second surface 65B of the first step portion 65 abuts against the second surface 72B of the second step portion 72; and the third surface 65C of the first step portion 65 abuts against the third surface 72C of the second step portion 72. Meanwhile, in FIG. 3(b), the first surface 65A of the first step portion 65 abuts against the second surface 72B of the second step portion 72; and the second surface 65B of the first step portion 65 abuts against the third surface 72C of the second step portion 72. In this case, the third surface 65C of the first step portion 65 does not abut against the first surface 72A of the second step portion 72. Further, in FIG. 3(c), the first surface 65A of the first step portion 65 abuts against the third surface 72C of the second step portion 72. In this case, the second surface 65B and third surface 65C of the first step portion 65 do not abut against the first surface 72A and second surface 72B of the second step portion 72 respectively. Here, after inserting the first male screw 34 of the connector 25 into the through hole 71 of the frame 66 of the mover 62 under any of the conditions shown in FIGS. 3(a) to 3(c), the first male screw 34 will be screwed to the female screw 64 of the piston 61. In this way, the piston 61 and the mover 62 will be coupled together. Moreover, after inserting the second male screw 35 of the connector 25 into an attachment hole that is not shown and formed in the center of the first leaf spring 28, the second male screw 35 will be screwed to the nut 47. In this way, the connector 25 and the first leaf spring 28 will be coupled together. In this manner, there is established an assembly of the piston 61, connector 25, mover 62 and first leaf spring 28.

In FIG. 3(a), a distance from the first surface 72A of the second step portion 72 to the tip end 61A of the piston 61 is identical to a length Lp of the piston 61. Meanwhile, in FIG. 3(b), since the piston 61 is at a location that is distant from the clamped portion 67 by the step dimension S between the first surface 72A and second surface 72B of the second step portion 72, the distance from the first surface 72A of the second step portion 72 to the tip end 61A of the piston 61 is Lp+S. Further, in FIG. 3(c), since the piston 61 is at a location that is distant from the clamped portion 67 by the step dimension 2S between the first surface 72A and third surface 72C of the second step portion 72, the distance from the first surface 72A of the second step portion 72 to the tip end 61A of the piston 61 is Lp+2S. That is, the static position of the tip end 61A of the piston 61 in FIG. 3(b) is more situated toward the displacer 16 than that in FIG. 3(a) by the length of S. Likewise, the static position of the tip end 61A of the piston 61 in FIG. 3(c) is more situated toward the displacer 16 than that in FIG. 3(a) by the length of 2S.

As such, by changing the static position of the tip end 61A of the piston 61, a volume of a compression chamber C formed in a cylinder 15 in a static state will also change. Further, as the volume of the compression chamber C in the static state changes, characteristics of the Stirling refrigerator 1 (e.g. lowest temperature achieved around an expansion chamber E, temperature drop rate, operation frequency and power consumption) will also change. In this way, by merely selecting which of the first surface 72A, second surface 72B and third surface 72C of the second step portion 72 shall be abutted against by the first surface 65A, second surface 65B and third surface 65C of the first step portion 65, the characteristics of the Stirling refrigerator 1 can be adjusted.

As described above, the present invention is such that: in the Stirling refrigerator 1 as a Stirling engine including the piston 61 as a reciprocating body that is configured to be able to reciprocate inside the cylinder 15 having the central axis line X, and the mover 62 of the linear motor 24 as a moving body that is coupled to and moves together with this piston 61, since there are provided the first step portion 65 and second step portion 72 as an adjustment mechanism capable of adjusting the static position of the tip end 61A of the piston 61 inside the cylinder 15 by adjusting the positional relation between the mover 62 and the piston 61, the characteristics of the Stirling refrigerator 1 can be easily adjusted.

Further, the adjustment mechanism is configured to include the first step portion 65 that is provided at the piston 61 and has the first surface 65A, second surface 65B and third surface 65C as multiple steps of abutting surfaces with different positions in the direction of the central axis line X; and the second step portion 72 that is provided at the mover 62 and has the first surface 72A, second surface 72B and third surface 72C as multiple steps of abutting surfaces with different positions in the direction of the central axis line X, in which these first step portion 65 and second step portion 72 are configured to face each other, and there can be selected which of the first surface 72A, second surface 72B and third surface 72C of the second step portion 72 shall be abutted against by the first surface 65A, second surface 65B and third surface 65C of the first step portion 65. Thus, the characteristics of the Stirling refrigerator 1 can be adjusted more easily without increasing mass or the number of components.

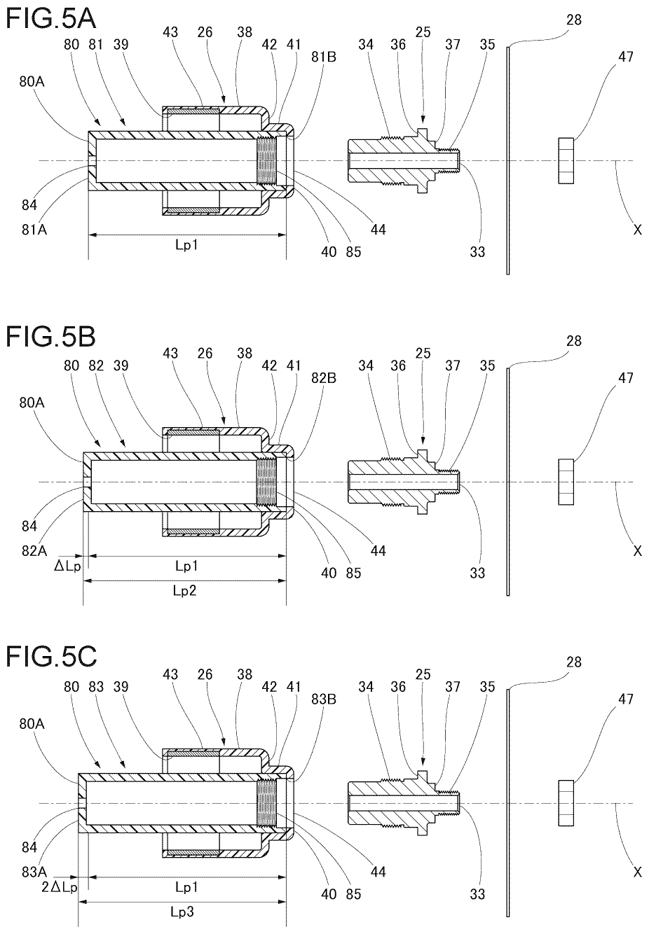

Next, a third embodiment of the present invention is described with reference to FIG. 5. Here, parts that correspond to those in the first embodiment are given the same numerical symbols, and the descriptions thereof are thus omitted.

An assembly is formed by a piston 80 as a reciprocating body, a connector 25 as a moving body, a mover 26 as a moving body, and a first leaf spring 28 as a control body. The piston 80 may be selected from any of a first piston 81, a second piston 82 and a third piston 83. The length of the first piston 81 in the direction of a central axis line X is Lp1. The length of the second piston 82 in the direction of the central axis line X is Lp2. The length of the third piston 83 in the direction of the central axis line X is Lp3. Here, a difference between Lp1 and Lp2 is ΔLp. Further, a difference between Lp2 and Lp3 is also ΔLp. That is, a difference between Lp1 and Lp3 is 2ΔLp. The first piston 81, the second piston 82 and the third piston 83 are identical to one another except for the lengths thereof in the direction of the central axis line X and the masses thereof. The pistons 81, 82 and 83 are each formed into the shape of a hollow cylinder. Further, formed in the center of each of tip ends 81A, 82A and 83A of these pistons 81, 82 and 83 is a through hole 84 allowing a rod 29 that is to be connected to a displacer 16 to be inserted therethrough. Further, a base end 81B side, a base end 82B side and a base end 83B side of the pistons 81, 82 and 83 are open, and a female screw 85 is formed on the inner surface of each of these opening portions.

A through hole 33 is formed in the connector 25 along the direction of the central axis line X, and the rod 29 is to be inserted through this through hole 33. Further, a first male screw 34 and a second male screw 35 are formed on both sides along the direction of the central axis line X. Moreover, there are formed a first clamping surface 36 and a second clamping surface 37 that are respectively proximal to the male screws 34 and 35. The mover 26 is configured to have a frame 38; and a cylindrical permanent magnet 39 fixed to a one end side of this frame 38. The frame 38 is made of a non-magnetic material such as a synthetic resin. Further, the frame 38 is configured in such a manner that it has a clamped portion 40 formed into an annular shape; a guiding cylinder portion 41 configured to extend from an outer circumferential portion of the clamped portion 40 along the central axis line X; an enlarged diameter portion 42 configured to extend outward from a tip end portion of the guiding cylinder portion 41; and a cylinder portion 43 configured to extend from an outer circumferential portion of this enlarged diameter portion 42 along the central axis line X. The permanent magnet 39 is fixed to the cylinder portion 43. Further, a through hole 44 allowing the first male screw 34 of the connector 25 to be inserted therethrough is formed on the clamped portion 40. Here, the first male screw 34 and the female screw 85 are to be screwed together through this through hole 44.

In this way, by screwing together the first male screw 34 and the female screw 85, the clamped portion 40 will be sandwiched by any of the base ends 81B, 82B and 83B of the pistons 81, 82 and 83 and the first clamping surface 36 of the connector 25. Thus, any of the pistons 81, 82 and 83, the connector 25 and the mover 26 are integrally combined together. At that time, the base end 81B side, base end 82B side and base end 83B side of the pistons 81, 82 and 83 are each to be inserted into the guiding cylinder portion 41 of the frame 38. A through hole (not shown) is formed in the central part of the first leaf spring 28, and the second male screw 35 is to be inserted through this through hole. Further, by allowing a nut 47 to be screwed to the second male screw 35 after inserting the second male screw 35 through the through hole, the first leaf spring 28 will be sandwiched by the second clamping surface 37 of the connector 25 and the nut 47.

Described hereunder is the adjustment of a static position of the tip end 80A of the piston 80. In FIG. 5(a), there is established an assembly of the first piston 81, mover 26, connector 25 and first leaf spring 28. In FIG. 5(b), there is established an assembly of the second piston 82, mover 26, connector 25 and first leaf spring 28. In FIG. 5(c), there is established an assembly of the third piston 83, mover 26, connector 25 and first leaf spring 28. Here, after inserting the first male screw 34 of the connector 25 into the through hole 44 of the frame 38 of the mover 26 under any of the conditions shown in FIGS. 5(a) to 5(c), the first male screw 34 will be screwed to the female screw 85 of any of the pistons 81, 82 and 83. In this way, any of the pistons 81, 82 and 83 and the mover 26 will be coupled together. Moreover, after inserting the second male screw 35 of the connector 25 into an attachment hole that is not shown and formed in the center of the first leaf spring 28, the second male screw 35 will be screwed to the nut 47. In this way, the connector 25 and the first leaf spring 28 will be coupled together. In this manner, there is established an assembly of any of the pistons 81, 82 and 83, connector 25, mover 26 and first leaf spring 28.

In FIG. 5(a), a distance from the clamped portion 40 to the tip end 81A of the piston 81 is identical to the length Lp 1 of the piston 81. Likewise, in FIG. 5(b), a distance from the clamped portion 40 to the tip end 82A of the piston 82 is identical to the length Lp2 of the piston 82. Further, in FIG. 5(c), a distance from the clamped portion 40 to the tip end 83A of the piston 83 is identical to the length Lp3 of the piston 83. That is, the static position of the tip end 80A of the piston 80 in FIG. 5(b) is more situated toward the displacer 16 than that in FIG. 5(a) by the length of ΔLp. Likewise, the static position of the tip end 80A of the piston 80 in FIG. 5(c) is more situated toward the displacer 16 than that in FIG. 5(a) by the length of 2ΔLp.

As such, by changing the static position of the tip end 80A of the piston 80, a volume of a compression chamber C formed in a cylinder 15 in a static state will also change. Further, as the volume of the compression chamber C in the static state changes, characteristics of the Stirling refrigerator 1 (e.g. lowest temperature achieved around an expansion chamber E, temperature drop rate, operation frequency and power consumption) will also change. In this way, by merely selecting which of the pistons 81, 82 and 83 with different lengths shall be used, the characteristics of the Stirling refrigerator 1 can be adjusted.

As described above, the present invention is such that: in the method for adjusting the Stirling refrigerator 1 as a Stirling engine including the piston 80 as a reciprocating body that is configured to be able to reciprocate inside the cylinder 15 having the central axis line X, and the mover 26 as a moving body that is coupled to and moves together with this piston 80, by employing the first piston 81, the second piston 82 and the third piston 83 with different lengths in the direction of the central axis line X and coupling any of these pistons to the mover 26, the static position of the tip end 80A of the piston 80 in the cylinder 15 can be adjusted, thereby allowing the characteristics of the Stirling refrigerator 1 to be adjusted easily.

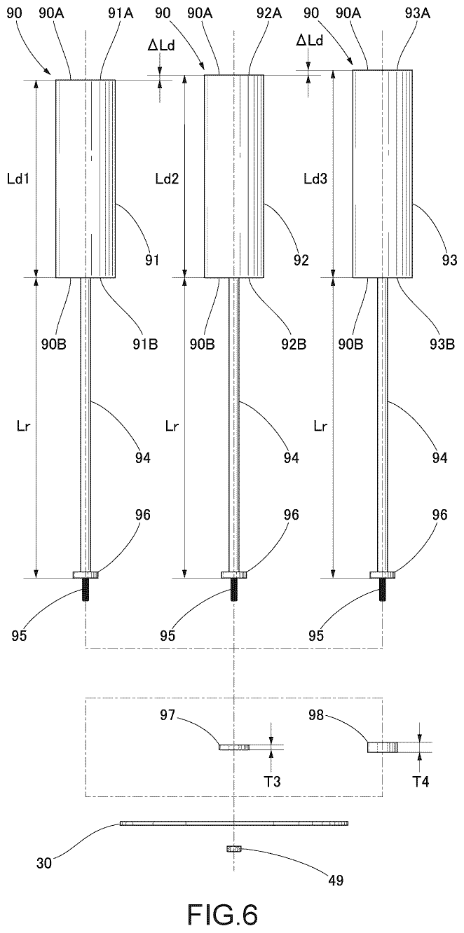

Next, a fourth embodiment of the present invention is described with reference to FIG. 6. Here, parts that correspond to those in the first embodiment are given the same numerical symbols, and the descriptions thereof are thus omitted.

A cylinder 15 is provided inside a casing 2. Further, a displacer 90 as a reciprocating body is housed inside a tip end side of the cylinder 15 in a manner such that the displacer 90 is capable of sliding along the direction of a central axis line X. The displacer 90 may be selected from any of a first displacer 91, a second displacer 92 and a third displacer 93. The length of the first displacer 91 in the direction of the central axis line X is Ld1. The length of the second displacer 92 in the direction of the central axis line X is Ld2. The length of the third displacer 93 in the direction of the central axis line X is Ld3. Here, a difference between Ld1 and Ld2 is ΔLd. Further, a difference between Ld2 and Ld3 is also ΔLd. That is, a difference between Ld1 and Ld3 is 2ΔLd. The first displacer 91, the second displacer 92 and the third displacer 93 are identical to one another except for the lengths thereof in the direction of the central axis line X and the masses thereof. Moreover, one end of a rod 94 as a moving body that moves together with the displacer 90 is connected to a base end 90B side of the displacer 90 (base end 91B side, base end 92B side, base end 93B side of the displacers 91, 92 and 93), and a second leaf spring 30 as a control body is connected to the other end of the rod 94. Here, the rod 94 is extended along the direction of the central axis line X by penetrating the center of a piston 23.

The rod 94 is described in detail hereunder. A male screw 95 is formed at the other end of the rod 94, and a flange portion 96 is formed at a base end portion of this male screw 95. When in a state where the rod 94 is connected to the displacer 90, a length of the rod 94 from the flange portion 96 to the base end 90B of the displacer 90 is Lr. Further, the male screw 95 can be inserted through a through hole that is not shown and is formed in the central part of the second leaf spring 30. Next, by allowing a nut 49 to be screwed to the male screw 95 after inserting the male screw 95 through the through hole, the second leaf spring 30 will be sandwiched by the flange portion 96 of the rod 94 and the nut 49. Here, an annular spacer 97 or 98 as an adjustment mechanism can be placed between the flange portion 96 of the rod 94 and the second leaf spring 30.

Described hereunder is the adjustment of a static position of the displacer 90. As shown in FIG. 6, the spacer 97 or 98 can be placed between the flange portion 96 of the rod 94 and the second leaf spring 30. However, it may be that neither the spacer 97 nor the spacer 98 is placed between the flange portion 96 of the rod 94 and the second leaf spring 30. The thickness of the spacer 97 is T3, and the thickness of the spacer 98 is T4. Here, T4 is twice as large as T3 (2T3=T4). Here, in this example, T3 is identical to ΔLd. In this regard, in the following descriptions, T3 is referred to as ΔLd, and T4 is referred to as 2ΔLd. Further, although not shown, instead of using the spacer 98, two spacers 97 may be stacked together along the direction of the central axis line X and placed between the flange portion 96 of the rod 94 and the second leaf spring 30. Moreover, the one end of the rod 94 is to be connected to any of the base ends 91B, 92B and 93B of the first displacer 91, second displacer 92 and third displacer 93. Moreover, after inserting the male screw 95 of the rod 94 into an attachment hole that is not shown and formed in the center of the second leaf spring 30, the male screw 95 will be screwed to the nut 49. Here, none of the spacers 97, 98, or any one of the spacers 97, 98 is placed between the flange portion 96 and the second leaf spring 30. In this way, the second leaf spring 30 will be sandwiched between the flange portion 96 of the rod 94 and the nut 49, whereby the rod 94 and the second leaf spring 30 will be coupled together. In this manner, there is established an assembly of the displacer 90, rod 94 and second leaf spring 30.

There exist the following nine patterns in terms of combination(s) of the assembly. Here, the rod 94 is omitted as it is used in common in all of these combinations.

TABLE 1

| Type of combination | Displacer | Spacer |
|---|---|---|
| Combination 1 | First displacer 91 | None |
| Combination 2 | First displacer 91 | Spacer 97 |
| Combination 3 | First displacer 91 | Spacer 98 |
| Combination 4 | Second displacer 92 | None |
| Combination 5 | Second displacer 92 | Spacer 97 |
| Combination 6 | Second displacer 92 | Spacer 98 |
| Combination 7 | Third displacer 93 | None |
| Combination 8 | Third displacer 93 | Spacer 97 |
| Combination 9 | Third displacer 93 | Spacer 98 |

A “combination 5” serves as a reference. In this combination, a distance from the second leaf spring 30 to a tip end 92A of the second displacer 92 is Ld2+Lr+ΔLd. Further, as opposed to this “combination 5,” in a “combination 4” where none of the spacers 97, 98 is inserted between the flange portion 96 and the second leaf spring 30, the distance from the second leaf spring 30 to the tip end 92A of the second displacer 92 is Ld2+Lr. That is, the static position of the entire second displacer 92 in the “combination 4” is more situated toward the piston 23 than that in the “combination 5” by a distance of ΔLd. In other words, a volume of an expansion chamber E in the “combination 4” in a static state is larger than that in the “combination 5” by ΔLd×πR2, and a volume of a compression chamber C in the “combination 4” in the static state is smaller than that in the “combination 5” by ΔLd×πR2. Likewise, as opposed to the “combination 5,” in a “combination 6” where the spacer 98 is inserted between the flange portion 96 and the second leaf spring 30, the distance from the second leaf spring 30 to the tip end 92A of the second displacer 92 is Ld2+Lr+2ΔLd. That is, the static position of the entire second displacer 92 in the “combination 6” is more situated toward a side opposite to the piston 23 than that in the “combination 5” by the distance of ΔLd. In other words, the volume of the expansion chamber E in the “combination 6” in the static state is smaller than that in the “combination 5” by ΔLd×πR2, and the volume of the compression chamber C in the “combination 6” in the static state is larger than that in the “combination 5” by ΔLd×πR2.

Further, in a “combination 2,” a distance from the second leaf spring 30 to a tip end 91A of the first displacer 91 is Ld1+Lr+ΔLd. Since Ld1=Ld2−ΔLd, the static position of the tip end 91A of the first displacer 91 in the “combination 2” is more situated toward the piston 23 than the static position of the tip end 92A of the second displacer 92 in the “combination 5” by the distance of ΔLd. However, as for the “combination 2” and the “combination 5,” since the rod 94 and the spacer 97 are used in common in both combinations, the static position of the base end 91B of the first displacer 91 in the “combination 2” is identical to the static position of the base end 92B of the second displacer 92 in the “combination 5.” In other words, while the volume of the expansion chamber E in the “combination 2” in the static state is larger than that in the “combination 5” by ΔLd×πR2, the volume of the compression chamber C in the “combination 2” in the static state is identical to that in the “combination 5.” Further, in a “combination 8,” a distance from the second leaf spring 30 to a tip end 93A of the third displacer 93 is Ld3+Lr+ΔLd. Since Ld3=Ld2+ΔLd, the static position of the tip end 93A of the third displacer 93 in the “combination 8” is more situated toward the side opposite to the piston 23 than the static position of the tip end 92A of the second displacer 92 in the “combination 5” by the distance of ΔLd. However, as for the “combination 8” and the “combination 5,” since the rod 94 and the spacer 97 are used in common in both combinations, the static position of the base end 93B of the third displacer 93 in the “combination 8” is identical to the static position of the base end 92B of the second displacer 92 in the “combination 5.” In other words, while the volume of the expansion chamber E in the “combination 8” in the static state is smaller than that in the “combination 5” by ΔLd×πR2, the volume of the compression chamber C in the “combination 8” in the static state is identical to that in the “combination 5.”

Further, in a “combination 3,” a distance from the second leaf spring 30 to the tip end 91A of the first displacer 91 is Ld1+Lr+2ΔLd. Here, since Ld1=Ld2−ΔLd, Ld1+Lr+2ΔLd=Ld2+Lr+ΔLd. Thus, the static position of the tip end 91A of the first displacer 91 in the “combination 3” is identical to the static position of the tip end 92A of the second displacer 92 in the “combination 5.” Meanwhile, while a distance from the second leaf spring 30 to the base end 92B of the second displacer 92 in the “combination 5” is Lr+ΔLd, a distance from the second leaf spring 30 to the base end 91B of the first displacer 91 in the “combination 3” is Lr+2ΔLd. Thus, the static position of the base end 91B of the first displacer 91 in the “combination 3” is more situated toward the side opposite to the piston 23 than the static position of the base end 92B of the second displacer 92 in the “combination 5” by the distance of ΔLd. In other words, while the volume of the compression chamber C in the “combination 3” in the static state is larger than that in the “combination 5” by ΔLd×πR2, the volume of the expansion chamber E in the “combination 3” in the static state is identical to that in the “combination 5.” Further, in a “combination 7,” a distance from the second leaf spring 30 to the tip end 93A of the third displacer 93 is Ld3+Lr. Here, since Ld3=Ld2+ΔLd, Ld3+Lr=Ld2+Lr+ΔLd. Thus, the static position of the tip end 93A of the third displacer 93 in the “combination 7” is identical to the static position of the tip end 92A of the second displacer 92 in the “combination 5.” Meanwhile, while the distance from the second leaf spring 30 to the base end 92B of the second displacer 92 in the “combination 5” is Lr+ΔLd, a distance from the third leaf spring 30 to the base end 93B of the third displacer 93 in the “combination 7” is Lr. Thus, the static position of the base end 93B of the third displacer 93 in the “combination 7” is more situated toward the piston 23 than the static position of the base end 92B of the second displacer 92 in the “combination 5” by the distance of ΔLd. In other words, while the volume of the compression chamber C in the “combination 7” in the static state is smaller than that in the “combination 5” by ΔLd×πR2, the volume of the expansion chamber E in the “combination 7” in the static state is identical to that in the “combination 5.”

Further, in a “combination 1,” the distance from the second leaf spring 30 to the tip end 91A of the first displacer 91 is Ld1+Lr. Since Ld1=Ld2−ΔLd, the static position of the tip end 91A of the first displacer 91 in the “combination 1” is more situated toward the piston 23 than the static position of the tip end 92A of the second displacer 92 in the “combination 5” by a distance of 2ΔLd. Meanwhile, in the “combination 1,” the distance from the second leaf spring 30 to the base end 91B of the first displacer 91 is Lr. That is, the static position of the base end 91B of the first displacer 91 in the “combination 1” is more situated toward the piston 23 than the static position of the base end 92B of the second displacer 92 in the “combination 5” by the distance of ΔLd. In other words, the entire displacer 91 in the “combination 1” is more situated toward the piston 23 than the entire displacer 92 in the “combination 5,” the volume of the expansion chamber E in the “combination 1” in the static state is larger than that in the “combination 5” by 2ΔLd×πR2, and the volume of the compression chamber C in the “combination 1” in the static state is smaller than that in the “combination 5” by ΔLd×πR2. Further, in a “combination 9,” the distance from the second leaf spring 30 to the tip end 93A of the third displacer 93 is Ld3+Lr+2ΔLd. Since Ld3=Ld2+ΔLd, the static position of the tip end 93A of the third displacer 93 in the “combination 9” is more situated toward the side opposite to the piston 23 than the static position of the tip end 92A of the second displacer 92 in the “combination 5” by the distance of 2ΔLd. Meanwhile, in the “combination 9,” the distance from the second leaf spring 30 to the base end 93B of the third displacer 93 is Lr+2ΔLd. That is, the static position of the base end 93B of the third displacer 93 in the “combination 9” is more situated toward the side opposite to the piston 23 than the static position of the base end 92B of the second displacer 92 in the “combination 5” by the distance of ΔLd. In other words, the entire displacer 93 in the “combination 9” is more situated toward the side opposite to the piston 23 than the entire displacer 92 in the “combination 5,” the volume of the expansion chamber E in the “combination 9” in the static state is smaller than that in the “combination 5” by 2ΔLd×πR2, and the volume of the compression chamber C in the “combination 9” in the static state is larger than that in the “combination 5” by ΔLd×πR2.

Table 2 summarizes these analyses. Here, the “combination 5” likewise serves as a reference in Table 2.

TABLE 2

| | Difference from reference | Difference from reference |
|---|---|---|
| Type of | static volume of expansion | static volume of |
| combination | chamber E | compression chamber C |
| Combination 1 | +2ΔLd × πR² | −ΔLd × πR² |
| Combination 2 | +ΔLd × πR² | No difference |
| Combination 3 | No difference | +ΔLd × πR² |
| Combination 4 | +ΔLd × πR² | −ΔLd × πR² |
| Combination 5 | (Reference) | (Reference) |
| Combination 6 | −ΔLd × πR² | +ΔLd × πR² |
| Combination 7 | No difference | −ΔLd × πR² |
| Combination 8 | −ΔLd × πR² | No difference |
| Combination 9 | −2ΔLd × πR² | +ΔLd × πR² |

In this way, by selecting any of the displacers 91, 92 and 93 as multiple kinds of displacers with different lengths in the direction of the central axis line X, and then coupling the displacer selected to the rod 94 and the second leaf spring 30, the static position of a tip end 90A of the displacer 90 can be adjusted. Further, at that time, by further inserting or not inserting the spacer(s) 97, 98 as an adjustment mechanism between the flange portion 96 of the rod 94 and the second leaf spring 30, the static position of the base end 90B of the displacer 90 can be adjusted. That is, via these combinations, the static positions of both the tip end 90A and base end 90B of the displacer 90 can be adjusted, or the static position of only one of the tip end 90A and base end 90B of the displacer 90 may be adjusted. In this way, as a result of adjusting the volume of the expansion chamber E formed on the tip end 90A side of the displacer 90 in the static state and the volume of the compression chamber C formed on the base end 90B side of the displacer 90 in the static state by adjusting the static position of the displacer 90, characteristics of the Stirling refrigerator 1 (e.g. lowest temperature achieved around the expansion chamber E, temperature drop rate, operation frequency and power consumption) can be adjusted.

As described above, the present invention is such that: in the Stirling refrigerator 1 as a Stirling engine including the displacer 90 as a reciprocating body that is configured to be able to reciprocate inside the cylinder 15 having the central axis line X, the rod 94 as a moving body that is coupled to and moves together with this displacer 90, and the second leaf spring 30 as a control body that is coupled to this rod 94 and controls the motions of the displacer 90 and the rod 94, since there is provided the spacer(s) 97, 98 as an adjustment mechanism capable of adjusting the static position of the displacer 90 inside the cylinder 15 by adjusting the positional relation between the rod 94 and the second leaf spring 30, the static position of the reciprocating body inside the cylinder 15 can be adjusted, whereby the characteristics of the Stirling refrigerator 1 can be easily adjusted.

Further, by employing, as the adjustment mechanism, the spacer 97, 98 that is provided between the rod 94 and the second leaf spring 30, the characteristics of the Stirling refrigerator 1 can be adjusted more easily.

Further, the present invention is such that: in the method for adjusting the Stirling refrigerator 1 as a Stirling engine including the displacer 90 as a reciprocating body that is configured to be able to reciprocate inside the cylinder 15 having the central axis line X, and the rod 94 as a moving body that is coupled to and moves together with this displacer 90, by employing the first displacer 91, the second displacer 92 and the third displacer 93 with different lengths in the direction of the central axis line X and coupling any of these displacers to the rod 94, the static position of the displacer 90 in the cylinder 15 can be adjusted, thereby allowing the characteristics of the Stirling refrigerator 1 to be adjusted easily.

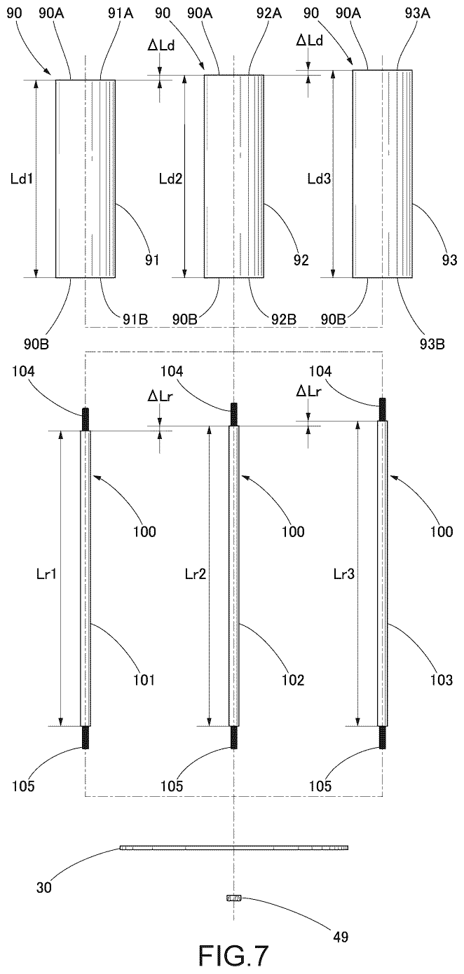

Next, a fifth embodiment of the present invention is described with reference to FIG. 7. Here, parts that correspond to those in the first embodiment are given the same numerical symbols, and the descriptions thereof are thus omitted.

A cylinder 15 is provided inside a casing 2. Further, a displacer 90 as a reciprocating body is housed inside a tip end side of the cylinder 15 in a manner such that the displacer 90 is capable of sliding along the direction of a central axis line X. The displacer 90 may be selected from any of a first displacer 91, a second displacer 92 and a third displacer 93. The length of the first displacer 91 in the direction of the central axis line X is Ld1. The length of the second displacer 92 in the direction of the central axis line X is Ld2. The length of the third displacer 93 in the direction of the central axis line X is Ld3. Here, a difference between Ld1 and Ld2 is ΔLd. Further, a difference between Ld2 and Ld3 is also ΔLd. That is, a difference between Ld1 and Ld3 is 2ΔLd. The first displacer 91, the second displacer 92 and the third displacer 93 are identical to one another except for the lengths thereof in the direction of the central axis line X and the masses thereof. Moreover, one end of a rod 100 as a moving body that moves together with the displacer 90 is connected to a base end 90B side of the displacer 90 (base end 91B side, base end 92B side, base end 93B side of the displacers 91, 92 and 93), and a second leaf spring 30 as a control body is connected to the other end of the rod 100. Here, the rod 100 is extended along the direction of the central axis line X by penetrating the center of a piston 23.

The rod 100 is described in detail hereunder. The rod 100 may be selected from any of a first rod 101, a second rod 102 and a third rod 103. A male screw 104 is formed at one end of each of these rods 101, 102 and 103. Further, a male screw 105 is formed at the other end of each of these rods 101, 102 and 103. Here, each male screw 104 is to be screwed to the center of the base end 90B of the displacer 90. A length of the first rod 101 excluding the male screws 104, 105 i.e. a length of the first rod 101 from the second leaf spring 30 to the base end 90B of the displacer 90 is Lr1. A length of the second rod 102 excluding the male screws 104, 105 i.e. a length of the second rod 102 from the second leaf spring 30 to the base end 90B of the displacer 90 is Lr2. A length of the third rod 103 excluding the male screws 104, 105 i.e. a length of the third rod 103 from the second leaf spring 30 to the base end 90B of the displacer 90 is Lr3. And, Lr3=Lr2+ΔLr=Lr1+2ΔLr. Here, in this example, ΔLr is identical to ΔLd. Thus, in the descriptions hereafter, ΔLr is referred to as ΔLd. Also, as for each of the rods 101, 102 and 103, the male screw 105 thereof can be inserted through a through hole that is not shown and is formed in the central part of the second leaf spring 30. Further, by allowing a nut 49 to be screwed to the male screw 105 after inserting the male screw 105 through the through hole, the second leaf spring 30 will be fixed to the base end side of the rod 100.

Described hereunder is the adjustment of a static position of the displacer 90. As shown in FIG. 7, as the displacer 90, there may be selected any of the first displacer 91, second displacer 92 and third displacer 93 with different lengths in the direction of the central axis line X. Likewise, as the rod 100, there may be selected any of the first rod 101, second rod 102 and third rod 103 with different lengths in the direction of the central axis line X. Further, one end of any of the rods 101, 102 and 103 is to be connected to any of the base ends 91B, 92B and 93B of the first displacer 91, second displacer 92 and third displacer 93. Moreover, after inserting the male screw 104 of the rod 100 into an attachment hole that is not shown and formed in the center of the second leaf spring 30, the male screw 104 will be screwed to the nut 49. In this manner, there is established an assembly of the displacer 90, rod 100 and second leaf spring 30.

There exist the following nine patterns in terms of combination(s) of the assembly.

TABLE 3

| Type of combination | Displacer | Rod |
|---|---|---|
| Combination 1 | First displacer 91 | Rod 101 |
| Combination 2 | First displacer 91 | Rod 102 |
| Combination 3 | First displacer 91 | Rod 103 |
| Combination 4 | Second displacer 92 | Rod 101 |
| Combination 5 | Second displacer 92 | Rod 102 |
| Combination 6 | Second displacer 92 | Rod 103 |
| Combination 7 | Third displacer 93 | Rod 101 |
| Combination 8 | Third displacer 93 | Rod 102 |
| Combination 9 | Third displacer 93 | Rod 103 |

A “combination 5” serves as a reference. In this combination, a distance from the second leaf spring 30 to a tip end 92A of the second displacer 92 is Ld2+Lr2. Further, as opposed to this “combination 5,” in a “combination 4” where the first rod 101 is connected to the second displacer 92, the distance from the second leaf spring 30 to the tip end 92A of the second displacer 92 is Ld2+Lr1=Ld2+Lr2−ΔLd. That is, the static position of the entire second displacer 92 in the “combination 4” is more situated toward the piston 23 than that in the “combination 5” by a distance of ΔLd. In other words, a volume of an expansion chamber E in the “combination 4” in a static state is larger than that in the “combination 5” by ΔLd×πR2, and a volume of a compression chamber C in the “combination 4” in a static state is smaller than that in the “combination 5” by ΔLd×πR2. Likewise, as opposed to the “combination 5,” in a “combination 6” where the third rod 103 is connected to the second displacer 92, the distance from the second leaf spring 30 to the tip end 92A of the second displacer 92 is Ld2+Lr3=Ld2+Lr2+ΔLd. That is, the static position of the entire second displacer 92 in the “combination 6” is more situated toward a side opposite to the piston 23 than that in the “combination 5” by the distance of ΔLd. In other words, the volume of the expansion chamber E in the “combination 6” in the static state is smaller than that in the “combination 5” by ΔLd×πR2, and the volume of the compression chamber C in the “combination 6” in the static state is larger than that in the “combination 5” by ΔLd×πR2.

Further, in a “combination 2,” a distance from the second leaf spring 30 to a tip end 91A of the first displacer 91 is Ld1+Lr2. Since Ld1=Ld2−ΔLd, the static position of the tip end 91A of the first displacer 91 in the “combination 2” is more situated toward the piston 23 than the static position of the tip end 92A of the second displacer 92 in the “combination 5” by the distance of ΔLd. However, as for the “combination 2” and the “combination 5,” since the second rod 102 is used in common in both combinations, the static position of the base end 91B of the first displacer 91 in the “combination 2” is identical to the static position of the base end 92B of the second displacer 92 in the “combination 5.” In other words, while the volume of the expansion chamber E in the “combination 2” in the static state is larger than that in the “combination 5” by ΔLd×πR2, the volume of the compression chamber C in the “combination 2” in the static state is identical to that in the “combination 5.” Further, in a “combination 8,” a distance from the second leaf spring 30 to a tip end 93A of the third displacer 93 is Ld3+Lr+ΔLd. Since Ld3=Ld2+ΔLd, the static position of the tip end 93A of the third displacer 93 in the “combination 8” is more situated toward the side opposite to the piston 23 than the static position of the tip end 92A of the second displacer 92 in the “combination 5” by the distance of ΔLd. However, as for the “combination 8” and the “combination 5,” since the second rod 102 is used in common in both combinations, the static position of the base end 93B of the third displacer 93 in the “combination 8” is identical to the static position of the base end 92B of the second displacer 92 in the “combination 5.” In other words, while the volume of the expansion chamber E in the “combination 8” in the static state is smaller than that in the “combination 5” by ΔLd×πR2, the volume of the compression chamber C in the “combination 8” in the static state is identical to that in the “combination 5.”

Further, in a “combination 3,” a distance from the second leaf spring 30 to the tip end 91A of the first displacer 91 is Ld1+Lr3. Here, although Ld1=Ld2−ΔLd, since Lr3=Lr2+ΔLd, Ld1+Lr3=Ld2+Lr2. Thus, the static position of the tip end 91A of the first displacer 91 in the “combination 3” is identical to the static position of the tip end 92A of the second displacer 92 in the “combination 5.” Meanwhile, while a distance from the second leaf spring 30 to the base end 92B of the second displacer 92 in the “combination 5” is Lr2, a distance from the second leaf spring 30 to the base end 91B of the first displacer 91 in the “combination 3” is Lr3=Lr2+ΔLd. Thus, the static position of the base end 91B of the first displacer 91 in the “combination 3” is more situated toward the side opposite to the piston 23 than the static position of the base end 92B of the second displacer 92 in the “combination 5” by the distance of ΔLd. In other words, while the volume of the compression chamber C in the “combination 3” in the static state is larger than that in the “combination 5” by ΔLd×πR2, the volume of the expansion chamber E in the “combination 3” in the static state is identical to that in the “combination 5.” Further, in a “combination 7,” a distance from the second leaf spring 30 to the tip end 93A of the third displacer 93 is Ld3+Lr. Here, although Ld3=Ld2+ΔLd, since Lr1=Lr2−ΔLd, Ld3+Lr1=Ld2+Lr2. Thus, the static position of the tip end 93A of the third displacer 93 in the “combination 7” is identical to the static position of the tip end 92A of the second displacer 92 in the “combination 5.” Meanwhile, while the distance from the second leaf spring 30 to the base end 92B of the second displacer 92 in the “combination 5” is Lr2, a distance from the third leaf spring 30 to the base end 93B of the third displacer 93 in the “combination 7” is Lr1=Ld2−ΔLd. Thus, the static position of the base end 93B of the third displacer 93 in the “combination 7” is more situated toward the piston 23 than the static position of the base end 92B of the second displacer 92 in the “combination 5” by the distance of ΔLd. In other words, while the volume of the compression chamber C in the “combination 7” in the static state is smaller than that in the “combination 5” by ΔLd×πR2, the volume of the expansion chamber E in the “combination 7” in the static state is identical to that in the “combination 5.”

Further, in a “combination 1,” the distance from the second leaf spring 30 to the tip end 91A of the first displacer 91 is Ld1+Lr1. Since Ld1=Ld2−ΔLd and Lr1=Lr2−ΔLd, Ld1+Lr1=Ld2+Lr2−Δ2Ld. Thus, the static position of the tip end 91A of the first displacer 91 in the “combination 1” is more situated toward the piston 23 than the static position of the tip end 92A of the second displacer 92 in the “combination 5” by a distance of 2ΔLd. Meanwhile, in the “combination 1,” the distance from the second leaf spring 30 to the base end 91B of the first displacer 91 is Lr1. As described above, since Lr1=Lr2−ΔLd, the static position of the base end 91B of the first displacer 91 in the “combination 1” is more situated toward the piston 23 than the static position of the base end 92B of the second displacer 92 in the “combination 5” by the distance of ΔLd. In other words, the entire displacer 91 in the “combination 1” is more situated toward the piston 23 than the entire displacer 92 in the “combination 5,” the volume of the expansion chamber E in the “combination 1” in the static state is larger than that in the “combination 5” by 2ΔLd×πR2, and the volume of the compression chamber C in the “combination 1” in the static state is smaller than that in the “combination 5” by ΔLd×πR2. Further, in a “combination 9,” the distance from the second leaf spring 30 to the tip end 93A of the third displacer 93 is Ld3+Lr3. Since Ld3=Ld2+ΔLd and Lr3=Lr2+ΔLd, Ld3+Lr3=Ld2+Lr2+Δ2Ld. Thus, the static position of the tip end 93A of the third displacer 93 in the “combination 9” is more situated toward the side opposite to the piston 23 than the static position of the tip end 92A of the second displacer 92 in the “combination 5” by the distance of 2ΔLd. Meanwhile, in the “combination 9,” the distance from the second leaf spring 30 to the base end 93B of the third displacer 93 is Lr3. As described above, since Lr3=Lr2+ΔLd, the static position of the base end 93B of the third displacer 93 in the “combination 9” is more situated toward the side opposite to the piston 23 than the static position of the base end 92B of the second displacer 92 in the “combination 5” by the distance of ΔLd. In other words, the entire displacer 91 in the “combination 9” is more situated toward the side opposite to the piston 23 than the entire displacer 92 in the “combination 5,” the volume of the expansion chamber E in the “combination 9” in the static state is smaller than that in the “combination 5” by 2ΔLd×πR2, and the volume of the compression chamber C in the “combination 9” in the static state is larger than that in the “combination 5” by ΔLd×πR2.

Table 4 summarizes these analyses. Here, the “combination 5” likewise serves as a reference in Table 4.

TABLE 4

| | Difference from reference | Difference from reference |
|---|---|---|
| Type of | static volume of expansion | static volume of |
| combination | chamber E | compression chamber C |
| Combination 1 | +2ΔLd × πR² | −ΔLd × πR² |
| Combination 2 | +ΔLd × πR² | No difference |
| Combination 3 | No difference | +ΔLd × πR² |
| Combination 4 | +ΔLd × πR² | −ΔLd × πR² |
| Combination 5 | (Reference) | (Reference) |
| Combination 6 | −ΔLd × πR² | +ΔLd × πR² |
| Combination 7 | No difference | −ΔLd × πR² |
| Combination 8 | −ΔLd × πR² | No difference |
| Combination 9 | −2ΔLd × πR² | +ΔLd × πR² |

In this way, by selecting and coupling together any of the displacers 91, 92 and 93 as multiple kinds of displacers with different lengths in the direction of the central axis line X and any of the rods 101, 102 and 103 as multiple kinds of rods with different lengths in the direction of the central axis line X, and by coupling any of the rods 101, 102 and 103 selected to the second leaf spring 30, the static position of a tip end 90A of the displacer 90 can be adjusted. That is, via these combinations of the displacer 90 and the rod 100, the static positions of both the tip end 90A and base end 90B of the displacer 90 can be adjusted, or the static position of only one of the tip end 90A and base end 90B of the displacer 90 may be adjusted. In this way, as a result of adjusting the volume of the expansion chamber E formed on the tip end 90A side of the displacer 90 in the static state and the volume of the compression chamber C formed on the base end 90B side of the displacer 90 in the static state by adjusting the static position of the displacer 90, characteristics of the Stirling refrigerator 1 (e.g. lowest temperature achieved around the expansion chamber E, temperature drop rate, operation frequency and power consumption) can be adjusted.

As described above, the present invention is such that: in the method for adjusting the Stirling refrigerator 1 as a Stirling engine including the displacer 90 as a reciprocating body that is configured to be able to reciprocate inside the cylinder 15 having the central axis line X, and the rod 100 as a moving body that is coupled to and moves together with this displacer 90, by employing the first displacer 91, the second displacer 92 and the third displacer 93 with different lengths in the direction of the central axis line X and coupling any of these displacers to the rod 100, the static position of the displacer 90 in the cylinder 15 can be adjusted, thereby allowing the characteristics of the Stirling refrigerator 1 to be adjusted easily.

Further, the present invention is such that: in the method for adjusting the Stirling refrigerator 1 as a Stirling engine including the displacer 90 as a reciprocating body that is configured to be able to reciprocate inside the cylinder 15 having the central axis line X, and the rod 100 as a moving body that is coupled to and moves together with this displacer 90, by employing the first rod 101, second rod 102 and third rod 103 as multiple rods with different lengths in the direction of the central axis line X and coupling any of these rods to the displacer 90, the static position of the displacer 90 in the cylinder 15 can be adjusted, thereby allowing the characteristics of the Stirling refrigerator 1 to be adjusted easily.

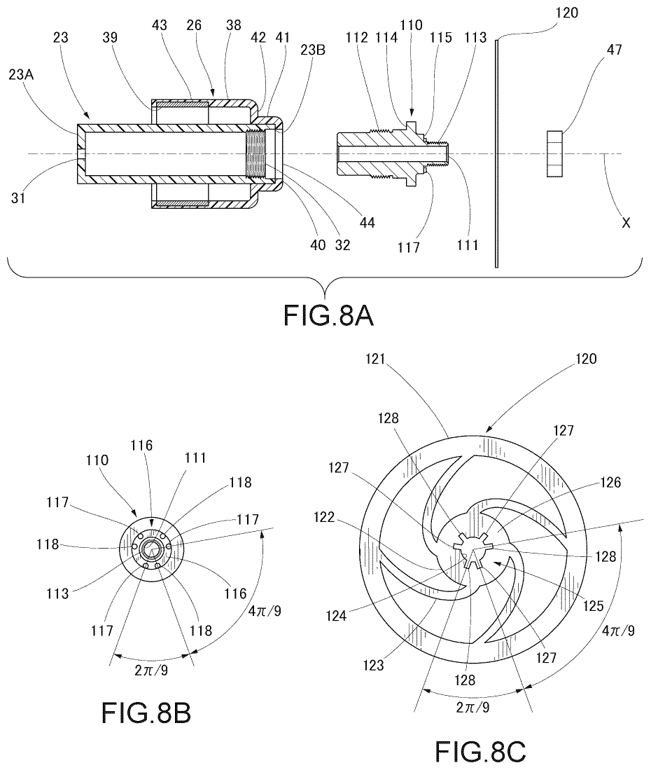

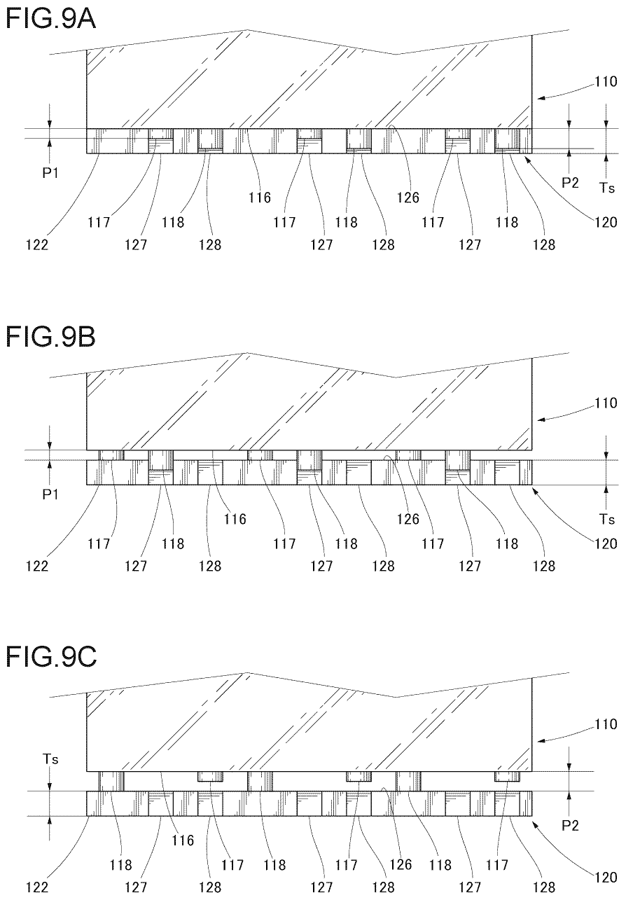

Next, a sixth embodiment of the present invention is described with reference to FIGS. 8 and 9. Here, parts that correspond to those in the first embodiment are given the same numerical symbols, and the descriptions thereof are thus omitted.

An assembly is formed by a piston 23 as a reciprocating body, a connector 110 as a moving body, a mover 26 as a moving body, and a first leaf spring 120 as a control body. The piston 23 is formed into the shape of a hollow cylinder. Further, formed in the center of a tip end 23A of the piston 23 is a through hole 31 allowing a rod 29 that is to be connected to a displacer 16 to be inserted therethrough. Further, a base end 23B side of the piston 23 is open, and a female screw 32 is formed on the inner surface of such opening portion.

A through hole 111 is formed in the connector 110 along the direction of a central axis line X, and the rod 29 is to be inserted through this through hole 111. Further, a first male screw 112 and a second male screw 113 are formed on both sides along the direction of the central axis line X. Moreover, there is formed a clamping surface 114 that is proximal to the first male screw 112. Further, a first step portion 115 composing an adjustment mechanism is formed in the proximity of the second male screw 113. This first step portion 115 has a planar counter surface 116 formed to surround the second male screw 113. In addition, centering around the central axis line X, a first protrusion 117 and a second protrusion 118 that compose the first step portion 115 are each formed and arranged at three locations on the counter surface 116 along the circumferential direction thereof. The first protrusions 117 themselves are apart from each other at an interval of 2π/3. Likewise, the second protrusions 118 themselves are apart from each other at an interval of 2π/3. Further, the first protrusion 117 and the second protrusion 118 are deviated from each other by an interval of 2π/9. As a result, the first protrusions 117 and second protrusions 118 are arranged in such a manner that the intervals of 2π/9 and 4π/9 exist alternately. Here, a protruding height of each first protrusion 117 from the counter surface 116 is P1; and a protruding height of each second protrusion 118 from the counter surface 116 is P2. And, P2=2P1.

The mover 26 is configured to have a frame 38; and a cylindrical permanent magnet 39 fixed to a one end side of this frame 38. The frame 38 is made of a non-magnetic material such as a synthetic resin. Further, the frame 38 is configured in such a manner that it has a clamped portion 40 formed into an annular shape; a guiding cylinder portion 41 configured to extend from an outer circumferential portion of the clamped portion 40 along the central axis line X; an enlarged diameter portion 42 configured to extend outward from a tip end portion of the guiding cylinder portion 41; and a cylinder portion 43 configured to extend from an outer circumferential portion of this enlarged diameter portion 42 along the central axis line X. The permanent magnet 39 is fixed to the cylinder portion 43. Further, a through hole 44 allowing the first male screw 112 of the connector 110 to be inserted therethrough is formed on the clamped portion 40. Here, the first male screw 112 and the female screw 32 are to be screwed together through this through hole 44. In this way, by screwing together the first male screw 112 and the female screw 32, the clamped portion 40 will be sandwiched by the base end 23B of the piston 23 and the first clamping surface 114 of the connector 110. Thus, the piston 23, the connector 110 and the mover 26 are integrally combined together. At that time, the base end 23B side of the piston 23 is to be inserted into the guiding cylinder portion 41 of the frame 38.

The first leaf spring 120 is formed in a way such that it integrally has an outer circumferential portion 121, a central portion 122, and a plurality of arm portions 123 connecting the outer circumferential portion 121 and the central portion 122. An attachment hole 124 is formed in the center of the central portion 122. Further, a second step portion 125 composing an adjustment mechanism is provided at the central portion 122 to surround the attachment hole 124. The second step portion 125 has a clamped portion 126; and a first cutout portion 127 and second cutout portion 128 for inserting the first protrusion 117 and the second protrusion 118. Here, the first cutout portion 127 and second cutout portion 128 are each formed and arranged at three locations on the second step portion 125 along the circumferential direction thereof, and in a manner such that they are continuous with the attachment hole 124. The first cutout portions 127 themselves are apart from each other at an interval of 2π/3. Likewise, the second cutout portions 128 themselves are apart from each other at an interval of 2π/3. Further, the first cutout portion 127 and the second cutout portion 128 are deviated from each other by an interval of 2π/9. As a result, the first cutout portions 127 and second cutout portions 128 are arranged in such a manner that the intervals of 2π/9 and 4π/9 exist alternately. Moreover, the first cutout portions 127 and the second cutout portions 128 are formed into widths allowing the first protrusions 117 and the second protrusions 118 to be inserted thereinto. In addition, the thickness of the clamped portion 126 is Ts. This thickness Ts is slightly larger than the protruding height P2 of the second protrusion 118. Next, by allowing a nut 47 to be screwed to the second male screw 113 after inserting the second male screw 113 through the attachment hole 124, the first leaf spring 120 will be sandwiched by the counter surface 116 side of the connector 110 and the nut 47.

Described hereunder is the adjustment of a static position of the tip end 23A of the piston 23. As shown in FIGS. 8 and 9, any of the counter surface 116 and first and second protrusions 117, 118 of the first step portion 115 is or are capable of abutting against the clamped portion 126 of the second step portion 125. Further, the first protrusion 117 can be inserted into the first cutout portion 127, and the second protrusion 118 can be inserted into the first cutout portion 127 or the second cutout portion 128. In FIG. 9(a), the counter surface 116 abuts against the clamped portion 126, all the first protrusions 117 are inserted into the first cutout portions 127, and all the second protrusions 118 are inserted into the second cutout portions 128. Meanwhile, in FIG. 9(b), the counter surface 116 and the clamped portion 126 are apart from each other, all the first protrusions 117 abut against the clamped portion 126, and all the second protrusions 118 are inserted into the first cutout portions 127. Further, in FIG. 9(c), the counter surface 116 and all the first protrusions 117 are apart from the clamped portion 126, and all the second protrusions 118 abut against the clamped portion 126. Here, after inserting the first male screw 112 of the connector 110 into the through hole 40 of the frame 38 of the mover 26 under any of the conditions shown in FIGS. 9(a) to 9(c), the first male screw 112 will be screwed to the female screw 32 of the piston 23. In this way, the piston 23 and the mover 26 will be coupled together. Moreover, after inserting the second male screw 113 of the connector 110 into the attachment hole 124 that is formed in the center of the central portion 122 of the first leaf spring 120, the second male screw 113 will be screwed to the nut 47. In this way, the connector 110 and the first leaf spring 120 will be coupled together. In this manner, there is established an assembly of the piston 23, connector 110, mover 26 and first leaf spring 120.

In FIG. 9(a), the counter surface 116 of the connector 110 abuts against the clamped portion 126 of the first leaf spring 120. In contrast, in FIG. 9(b), the counter surface 116 of the connector 110 and the clamped portion 126 of the first leaf spring 120 are apart from each other by the protruding dimension P1 of the first protrusion 117. Thus, in this case, the static position of the tip end 23A of the piston 23 connected to the connector 110 is situated toward the displacer 16 by the dimension of P1. Likewise, in FIG. 9(c), the counter surface 116 of the connector 110 and the clamped portion 126 of the first leaf spring 120 are apart from each other by the protruding dimension P2 of the second protrusion 118. Thus, in this case, the static position of the tip end 23A of the piston 23 connected to the connector 110 is situated toward the displacer 16 by the dimension of P2.

As such, by changing the static position of the tip end 23A of the piston 23, a volume of a compression chamber C formed in a cylinder 15 in a static state will also change. Further, as the volume of the compression chamber C in the static state changes, characteristics of the Stirling refrigerator 1 (e.g. lowest temperature achieved around an expansion chamber E, temperature drop rate, operation frequency and power consumption) will also change. In this way, by merely selecting which of the counter surface 116, first protrusion(s) 117 and second protrusion(s) 118 of the connector 110 shall abut against the clamped portion 126 of the first leaf spring 120, the characteristics of the Stirling refrigerator 1 can be adjusted.

As described above, the present invention is such that: in the Stirling refrigerator 1 as a Stirling engine including the piston 23 as a reciprocating body that is configured to be able to reciprocate inside the cylinder 15 having the central axis line X, the mover 26 of a linear motor 24 and the connector 110 as moving bodies that are coupled to and move together with this piston 23, and the first leaf spring 120 as a control body, since there are provided the first step portion 115 and second step portion 125 as an adjustment mechanism capable of adjusting the static position of the tip end 23A of the piston 23 inside the cylinder 15 by adjusting the positional relation between the connector 110 and the first leaf spring 120, the characteristics of the Stirling refrigerator 1 can be easily adjusted.

Further, the adjustment mechanism is configured to include the first step portion 115 that is provided at the connector 110 and has the counter surface 116, first protrusions 117 and second protrusions 118 as multiple steps of abutting surfaces with different positions in the direction of the central axis line X; the clamped portion 126 that is provided at the first leaf spring 120 and serves as an abutting surface; and the second step portion 125 that has the first cutout portions 127 and second cutout portions 128 for inserting the first protrusions 117 and the second protrusions 118, in which these first step portion 115 and second step portion 125 are configured to face each other, and there can be selected which of the counter surface 116, first protrusion(s) 117 and second protrusion(s) 118 of the first step portion 115 shall abut against the clamped portion 126 of the second step portion 125. Thus, the characteristics of the Stirling refrigerator 1 can be adjusted more easily without increasing mass or the number of components.

However, the present invention shall not be limited to the above embodiments; the invention may be variously modified and exploited within the scope of the gist of the present invention. For example, in each of the above embodiments, although the static position of the reciprocating unit can be adjusted in three stages, it may be adjusted in any number of stages.

### DESCRIPTION OF THE SYMBOLS

1 Stirling refrigerator (Stirling engine)

15 Cylinder

16 Displacer (reciprocating body)

23 Piston (reciprocating body)

23A Tip end

23B Base end

25 Connector (moving body)

26 Mover (moving body)

28 First leaf spring (control body)

29 Rod (moving body)

30 Second leaf spring (control body)

45 Spacer (adjustment mechanism)

46 Spacer (adjustment mechanism)

61 Piston (reciprocating body)

61A Tip end

61B Base end

62 Mover (moving body)

65 First step portion (adjustment mechanism)

65A First surface (abutting surface)

65B Second surface (abutting surface)

65C Third surface (abutting surface)

72 Second step portion (adjustment mechanism)

72A First surface (abutting surface)

72B Second surface (abutting surface)

72C Third surface (abutting surface)

80 Piston (reciprocating body)

81 First piston (reciprocating body)

81A Tip end

81B Base end

82 Second piston (reciprocating body)

82A Tip end

82B Base end

83 Third piston (reciprocating body)

83A Tip end

83B Base end

90 Displacer (reciprocating body)

90A Tip end

90B Base end

91 First displacer (reciprocating body)

91A Tip end

91B Base end

92 Second displacer (reciprocating body)

92A Tip end

92B Base end

93 Third displacer (reciprocating body)

93A Tip end

93B Base end

94 Rod (moving body)

97 Spacer (adjustment mechanism)

98 Spacer (adjustment mechanism)

100 Rod (moving body)

101 First rod (moving body)

102 Second rod (moving body)

103 Third rod (moving body)

110 Connector (moving body)

115 First step portion (adjustment mechanism)

116 Counter surface (adjustment mechanism)

117 First protrusion (adjustment mechanism)

118 Second protrusion (adjustment mechanism)

120 First leaf spring (control body)

125 Second step portion (adjustment mechanism)

126 Clamped portion (adjustment mechanism)

127 First cutout portion (adjustment mechanism)

128 Second cutout portion (adjustment mechanism)

X Central axis line

S Step dimension

Ld1 Length of first displacer 91

Ld2 Length of second displacer 92

Ld3 Length of third displacer 93

Lp Length of piston

Lp1 Length of first piston 81

Lp2 Length of second piston 82

Lp3 Length of third piston 83

Lr Length of rod 94

Lr1 Length of first rod 101 excluding male screw

Lr2 Length of second rod 102 excluding male screw

Lr3 Length of third rod 103 excluding male screw

P1 Protruding height of first protrusion 117 from counter surface 116

P2 Protruding height of second protrusion 118 from counter surface 116

Ts Thickness of clamped portion 126

T1 Thickness of spacer 45

T2 Thickness of spacer 46

T3 Thickness of spacer 97

T4 Thickness of spacer 98

ΔLd Difference between Ld1 and Ld2; difference between Ld2 and Ld3

ΔLp Difference between Lp1 and Lp2; difference between Lp2 and Lp3

ΔLr Difference between Lr1 and Lr2; difference between Lr2 and Lr3

1. A Stirling engine comprising:
a reciprocating body that is configured to be able to reciprocate inside a cylinder having a central axis line;
a moving body that is coupled to and moves together with the reciprocating body; and
an adjustment mechanism capable of adjusting an initial position of the reciprocating body inside the cylinder by adjusting a positional relation between the moving body and the reciprocating body.

2. The Stirling engine according to claim 1, wherein the adjustment mechanism is a spacer(s) provided between the moving body and the reciprocating body.

3. The Stirling engine according to claim 1, wherein the adjustment mechanism is configured to include a first step portion provided at the reciprocating body and a second step portion provided at the moving body, at least one of the first step portion and the second step portion has multiple steps of abutting surfaces with different positions in the direction of the central axis line, the first step portion and the second step portion are configured to face each other, and there can be selected the abutting surfaces of the first step portion and second step portion that are to abut against each other.

4. A Stirling engine comprising:
a reciprocating body that is configured to be able to reciprocate inside a cylinder having a central axis line;
a moving body that is coupled to and moves together with the reciprocating body;
a control body that is coupled to the moving body and controls the motions of the reciprocating body and the moving body; and
an adjustment mechanism capable of adjusting an initial position of the reciprocating body inside the cylinder by adjusting a positional relation between the moving body and the control body.

5. The Stirling engine according to claim 4, wherein the adjustment mechanism is a spacer(s) provided between the moving body and the control body.

6. The Stirling engine according to claim 4, wherein the adjustment mechanism is configured to include a first step portion provided at the moving body and a second step portion provided at the control body, at least one of the first step portion and the second step portion has multiple steps of abutting surfaces with different positions in the direction of the central axis line, the first step portion and the second step portion are configured to face each other, and there can be selected the abutting surfaces of the first step portion and second step portion that are to abut against each other.

7. A method for adjusting a Stirling engine that comprises:
a reciprocating body that is configured to be able to reciprocate inside a cylinder having a central axis line; and
a moving body that is coupled to and moves together with the reciprocating body, wherein an initial position of the reciprocating body inside the cylinder is adjusted by employing a plurality of the reciprocating bodies with different lengths in the direction of the central axis line and coupling any of these reciprocating bodies to the moving body.

8. A method for adjusting a Stirling engine that comprises:
a reciprocating body that is configured to be able to reciprocate inside a cylinder having a central axis line; and
a moving body that is coupled to and moves together with the reciprocating body, wherein an initial position of the reciprocating body inside the cylinder is adjusted by employing a plurality of the moving bodies with different lengths in the direction of the central axis line and coupling any of these moving bodies to the reciprocating body.
